(19) United States
(12) Patent Application Publication
(10) Pub. No.: US 2010/0093318 A1
(43) Pub. Date: Apr. 15, 2010

(54) METHODS AND SYSTEMS FOR LICENSE DISTRIBUTION FOR TELECOM APPLICATIONS

(76) Inventors: Zhongwen Zhu, Quebec (CA); Li Ally Lv, Shanghai (CN); Cheng Charles Wang, Shanghai (CN); Hongxia Lawrence Long, Kunshan (CN)

Correspondence Address: ERICSSON INC., 6300 LEGACY DRIVE, M/S EVR 1-C-11, PLANO, TX, 75024, US

(21) Appl. No.: 12/249,565

(22) Filed: Oct. 10, 2008

(51) Int. Cl. H04M 3/42; H04W 4/12; H04W 72/00

(52) U.S. Cl. 455/414.1; 455/466; 455/453

(57) ABSTRACT

Methods and systems for license control associated with telecommunication services are described. An incoming service request can be selectively processed without first checking for license compliance. For example, an incoming request can first be served and then subsequently license compliance can be checked. Periodically, a license server can replenish its license tokens for the service. If a request for license tokens is under fulfilled, then subsequent incoming service requests can be checked for license compliance before the communication service is provided.

### TECHNICAL FIELD

The present invention generally relates to license distribution and, more particularly, to methods, devices, systems and software for distributing licenses associated with telecom applications.

### BACKGROUND

Communication devices and systems in general, and messaging systems particular, continue to gain in popularity. Paging, instant messaging (IM), text messaging on cell phones (e.g., SMS) and multimedia messaging (MMS) are examples of messaging systems which have enjoyed popularity over the years. Next generation systems, e.g., IP Multimedia Subsystem (IMS) will also include messaging systems and services. In order to enrich end-user experience and allow the end-user more freedom in choosing media formats, the capabilities of messaging services are continuously being improved. With the advent of multimedia and 3G (and soon 4G) in the telecommunication area, it is technically no longer necessary to predicate the manner in which communications are performed on the type of media that is being communicated, i.e., 3G and 4G telecommunications are intended to be more media independent than previous generations of communications technology.

Messaging services are typically supplied by way of software applications running on communication nodes or servers. The vendors of such software applications may charge their customers for their use of the messaging software based on the amount of messaging traffic which is being handled in a particular time frame. Accordingly, monitoring techniques and software are typically provided in such communication nodes to keep track of the usage of messaging application software so that both the software vendor and the customer can ensure that an appropriate license has been purchased for the actual usage of the messaging services.

In general there are two types of licensing mechanisms in use today. One type is the so-called “on-off” license which is typically used to control, e.g., software loaded onto one's personal computer. When the software is loaded, a license key is required to be input in order to activate the software. When a valid key is entered, the software is unlocked; however absent entry of a valid license key, the software remains off. Another type of licensing mechanism is one which controls the number of users which are permitted to access the service provided by the software. This latter type of license is more appropriate for telecom applications.

Consider, for example, the generic structure of a traffic node in a telecom system and its associated licensing control mechanism as shown in FIG. 1. Therein, the traffic node 100 includes several traffic processors (TP) 102 which handle traffic for a messaging service, such as TP1, TP2, TP3 and TP4. Those skilled in the art will appreciate that such nodes may have more than four traffic processors, which number is purely exemplary. A license server 104 is used to control the legal usage of the messaging software/service in the node 100 by distributing license tokens to the local license managers 103 of each of the traffic processors 102. Each of the tokens is “consumed” when, for example, a new messaging session is established as a result of incoming traffic. A load balancer 106 is used to keep the traffic even across all the traffic processors 102. Since it is possible to deploy more than one service in a node 100, the load balancing will typically be performed for the overall traffic load, e.g., across several services, instead of for just one specific service. Thus, a specific service may have an uneven distribution of its service traffic across the different traffic processors, as reflected by the rightmost bar illustrated within each traffic processor 102, also referred to therein as “Used RTUs”, i.e., used right-to-use tokens.

A conventional way to handle license token distribution is to provide a local license manager 103 on each traffic processor 102 which reserves license tokens from the license server 104, e.g., at start-up or at the beginning of an operating cycle. Normally the number of license tokens to be reserved in a request from a license manager is initially over-estimated in order to avoid blocking traffic on a given, local traffic processor 102. The license tokens received by a local traffic processor 102 from the license server 104 in response to a request are then used to control the number of incoming requests for the service on that traffic processor 102.

When tokens are not used according to the percentage of traffic load, the tokens are returned or released to the license server 104, which tokens can then be used by other traffic processors 102. When the local license tokens are used up, the local license manager 103 on that processor 102 makes another request towards the license server 104 to reserve new license tokens. At the same time, the incoming service request for which the local license manager 103 did not possess another license token is either held in a queue (that will be processed when the license token is received) or rejected.

Thus, uneven traffic distribution exacerbates the problem of license control since a uniform distribution of license tokens or RTUs across all of the traffic processors may not be optimal depending upon the imbalance of traffic for the licensed service from one traffic processor to the next. For example, uniform token distribution might cause traffic blockages at a particular traffic processor if the number of requests on that processor suddenly increases and exceeds the number of reserved licenses which were received based upon a uniform distribution algorithm. Typically, however, the operator (i.e., the customer of the software vendor) does not want service traffic to be blocked, as that causes problems with its customers, e.g., end users sending messages using the message service. Accordingly, new methods and systems for distributing licenses in telecom applications are desirable.

### SUMMARY

According to an exemplary embodiment, a method for monitoring license compliance in a communications network includes the steps of receiving an incoming request for a communication service, checking for compliance with a license associated with said communication service based on a value of a license verification indicator, and providing said communication service for said incoming request.

According to another exemplary embodiment, a communications node for providing a communication service includes at least one traffic processor for providing the communication service, and a local license manager entity, associated with each of the at least one traffic processors, which checks for compliance with a license associated with an incoming request for the communication service based on a value of a license verification indicator.

According to another exemplary embodiment, a computer-readable medium contains program instructions which, when executed by a computer or processor, perform the steps of receiving an incoming request for a communication service, checking for compliance with a license associated with the communication service based on a value of a license verification indicator, and providing the communication service for the incoming request.

According to still another exemplary embodiment, a method for monitoring license compliance in a communications network includes the steps of receiving an incoming request for a communication service, and selectively processing the incoming request for the communication service without initially checking for compliance with a license associated with the communication service.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 illustrates an exemplary communications node including traffic processors and a licensing server which can be used to implement exemplary embodiments;

FIG. 2 illustrates a messaging node including a plurality of message servers according to an exemplary embodiment;

FIG. 3 is a flow chart illustrating a method for monitoring license compliance according to an exemplary embodiment;

FIG. 4 is a graph illustrating service load and license tokens as a function of time according to an exemplary embodiment;

FIG. 5 is a graph illustrating a number of reserved license tokens as a function of time according to an exemplary embodiment;

FIG. 6 is a flowchart illustrating a method for reserving license tokens and selectively activating license verification according to an exemplary embodiment;

FIG. 7 is a flowchart illustrating a method for processing incoming service requests according to an exemplary embodiment;

FIG. 8 is a flowchart depicting processing after event termination according to an exemplary embodiment;

FIG. 9 shows a communications node according to an exemplary embodiment;

FIG. 10 is a flowchart illustrating a method for license control according to an exemplary embodiment; and

FIG. 11 is a flowchart illustrating a method for license control according to another exemplary embodiment.

### DETAILED DESCRIPTION

The following description of the exemplary embodiments of the present invention refers to the accompanying drawings. The same reference numbers in different drawings identify the same or similar elements. The following detailed description does not limit the invention. Instead, the scope of the invention is defined by the appended claims.

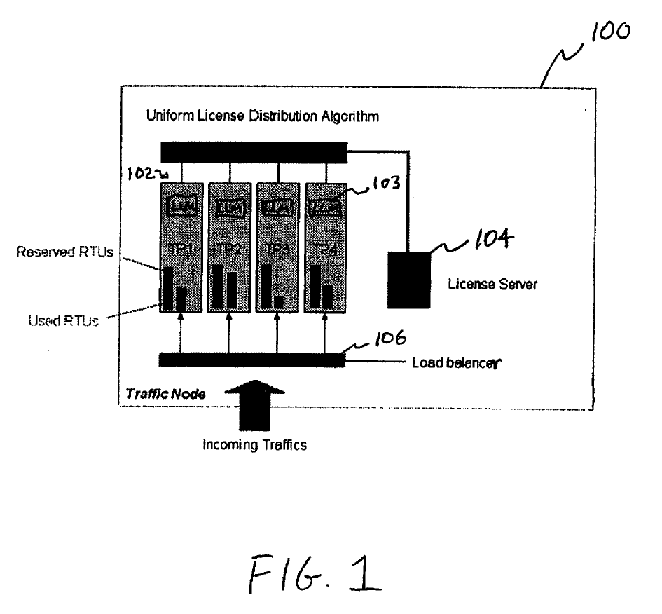

Referring again to FIG. 1, it will thus be appreciated that, for a capacity based license, one of the challenges is to distribute the license tokens optimally across different traffic processors in the same traffic node 100. Having the right number of tokens associated with each traffic processor 102 in advance of receiving service requests from end users is important because it may take too much time to access the license server 104 directly during the session setup for the service to request a needed token. Conventional license distribution techniques operate on the principle of verifying that a license or license token is available before permitting the service request to be fulfilled. However the exemplary embodiments described below operate, at least in part, on a different principle, e.g., fulfilling the service request first and then checking to see if a license or license token can be matched to the fulfilled service request.

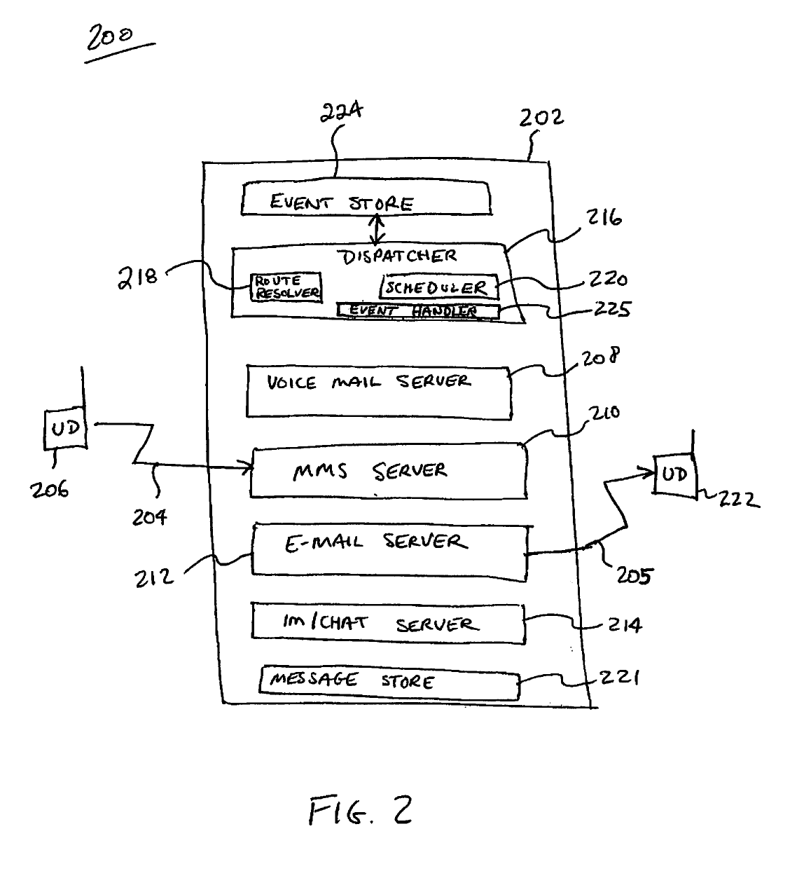

In order to provide some context for this discussion regarding license distribution, an exemplary messaging system will first be described with respect to FIG. 2, although it will be appreciated that the present invention is not limited to messaging systems or services but may be applied to any type of service to be monitored via a licensing mechanism. As shown generally in FIG. 2, a messaging system 200 includes a messaging server node 202 which receives a message 204 to be sent from a user device (UD) 206, e.g., a mobile phone, a computer, an IPTV STB (Set-Top Box), etc., or from a proxy server or other messaging node. The message 204 will, among other things, identify a recipient and/or a recipient's UD. The messaging server 202 may, as shown, include a plurality of servers (protocol handlers) such as a voice mail server 208, an MMS server 210, an e-mail server 212, and an IM/Chat server 214. In this example, these four types of message servers are co-located, i.e., share the same server hardware. It will be appreciated by those skilled in the art that the messaging server 202 may include more or fewer message server types than are illustrated in FIG. 2.

The messaging server node 202 will also typically have a dispatcher 216 associated, that is optionally co-located, with the one or more message servers 208-214. The dispatcher 216 can include, for example, two functional entities: a route resolver 218 which decides which messaging server type to use for message delivery, and a scheduler 220 which decides when to deliver the message. Among other things, for example, these functional entities of the dispatcher 216 decide which messaging server to invoke for delivery of the message 204 and when to invoke delivery of the message 204 based on, for example, preferences of the recipient, e.g. user profile, presence, etc. If the dispatcher cannot immediately route the message 204 to its intended recipient, it will store it in a message store 221 for later delivery. This may occur for a number of different reasons. For example, if the message indicates that it shall be delivered at later time or if the intended recipient is not online, then the message can be stored in message store 221 for later delivery. Similarly, if the message 204 requires interworking between message servers of different message types, the message 204 can also be stored in message store 221 for subsequent forwarding by the dispatcher 216.

With respect to this latter example, and of particular interest for the exemplary embodiments described below, the scheduler 220 can store a delivery event in an event store 224 which indicates, e.g., during which upcoming time slot the message 204 should be delivered to the intended recipient. For every time slot, the scheduler 220 can then check the event store 224 to determine whether any events are scheduled for that particular time slot. If an event is scheduled for the current time slot, then the scheduler 220 can call an event handler 225 that further processes the event as described below. When the scheduler 220 has performed all of its scheduled events for a particular time or time slot, it may then check to see if any past events still need to be handled. Although not shown in FIG. 2 in order to simplify the Figure, it will be understood that the various functional entities illustrated therein are connected to one another in the manner needed to communicate and perform the functions described herein.

When the scheduler 220 identifies that a message is to be delivered as indicated by an event in the event store 224, the event handler 225 is called and it invokes certain procedures for delivering the message. The specific procedures which are invoked will depend upon, e.g., the identity and location of the messaging server which is to perform the delivery. Referring to FIG. 2, the message 205 may be sent to the recipient's UD 222, proxy servers (not shown) or other message servers using one of the co-located servers 208, 212 or 214. For example, the message 204 may be sent to the originating messaging server node 202, i.e., MMS server 210, as an MMS message and the recipient's preferences may indicate that MMS messages which are addressed to UD 222 are to be delivered as e-mails. Thus, the dispatcher 216 (via route resolver 218) may determine that this particular message 204 is to be delivered by e-mail server 212 which is co-located therewith. In this case, when the scheduled event fires, the event handler 225 may invoke an application programming interface (API) associated with the originating messaging server 202 to use the co-located email server 212 as the terminating message server to deliver message 205 to UD 222.

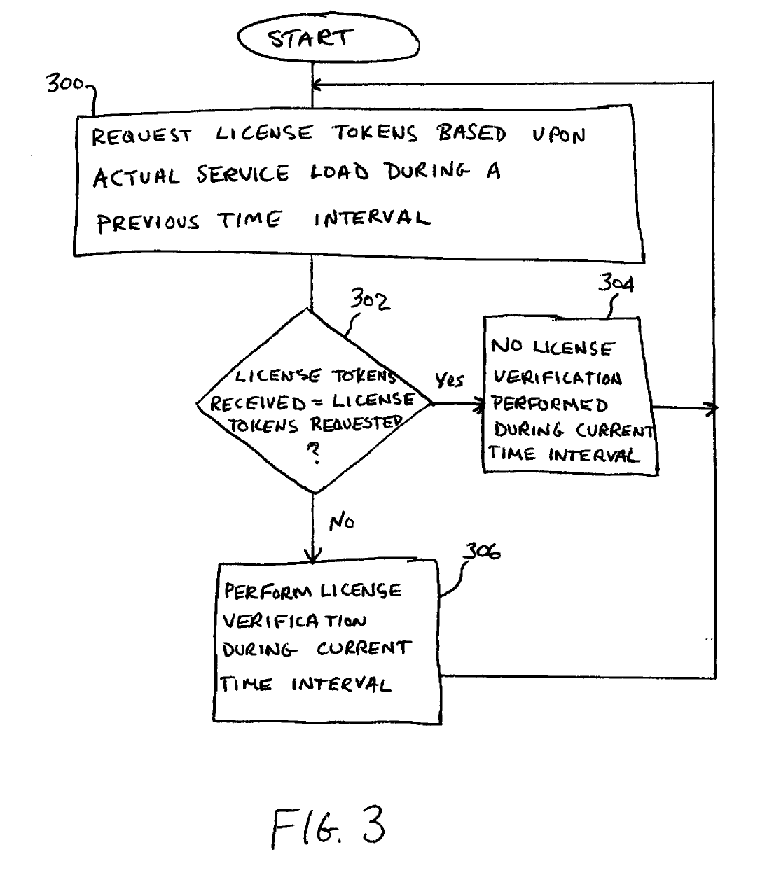

Any one or more of the messaging services which are supported using the messaging server node 202 described above can also have a license server 104 which monitors their activity level for license compliance in accordance with these exemplary embodiments. Each server 208-214 can have its respective service distributed over various traffic processors 102. As mentioned above, these exemplary embodiments operate to provide the requested service first and then to subsequently verify that the performed service was within the scope of the license terms. In general, a license monitoring method according to an exemplary embodiment can be described as shown in the flowchart of FIG. 3.

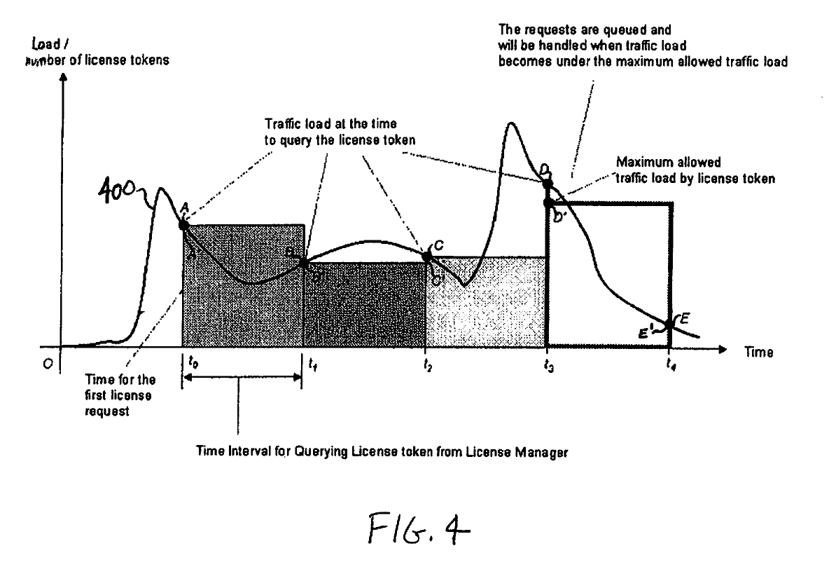

A local license manager 103, e.g., a software entity associated with a particular messaging service operating on each traffic processor 102 or on another processor, periodically requests license tokens from the license server 104 based upon the actual traffic load associated with that service during a previous time interval at step 300. This token request operation can be performed by the local license manager 103 at varying time intervals, for example, in a manner described below with respect to FIG. 4. Generally, according to this exemplary embodiment, when the number of license tokens which are received in the response received from the license server 104 is the same as the number of license tokens requested from the license server 104, as determined at step 302, no license verification for incoming service requests is performed by the local traffic processor 102 during the current time interval as shown in step 304, i.e., until the next time that the local license manager performs the license token update based on the determined time interval. If, on the other hand, the number of license tokens received in the response from the license server 104 is less than the number of license tokens requested from the license server 104 (e.g., because no more license tokens are available in license server 104 for that service at that particular time), then the local license manager 103, at step 306, performs a license verification for each incoming service request on that local processor 102 during the current time interval.

While in the license verification state 306, if an incoming service request exceeds the limit imposed by the license server 104, then the local license manager 103 can put this incoming service request at the end of a queue of service requests. This delays the unlicensed service from being performed until later. For example, when one of the ongoing service events is successfully terminated, the first service request listed in the queue can be processed.

The manner in which license control can be implemented according to the exemplary embodiment of FIG. 3 will be better understood by considering the load diagram of FIG. 4, which also shows requests for license tokens by a local license manager 103. Therein, an actual, measured service load associated with a particular licensed service, e.g., a number of ongoing messaging sessions, operating on one traffic processor 102 is shown as a function 400 of time. Various time intervals are shown, which are delineated by time points t₀, t₁, t₂, t₃, and t₄ The points t₀, t₁, t₂, t₃, and t₄ are the times when, according to this exemplary embodiment, the local license manager 103 queries the license server 104 to obtain license tokens for this service.

Before time t₀, there is no license verification according to this exemplary embodiment. Instead, the traffic load starts at zero, is supported by the local processor 102, and ramps up. Then at time t₀, the local license manager 103 retrieves the traffic load, e.g., from an entity or function (not shown) responsible for measuring traffic, at point A. The local license manager 103 sends a first license request message towards license server 104 at this time. According to one exemplary embodiment, the number of license tokens requested in the license request message can be equal to the instantaneous value of the traffic load, e.g., A. According to other exemplary embodiments, the number of license tokens requested can instead be a function of the value A. In this example, license server 104 reserves the requested number of license tokens for this traffic processor 102 and sends a response back to the local license manager 103 in which the number of the requested license tokens is honored. This is shown graphically in FIG. 4 by point A and point A′ being the same points. Recognizing this, the local license manager 103 sets, e.g., its license verification flag to be “False”, e.g., so that the license verification enters the state 304 in the flowchart of FIG. 3.

During the next time interval, i.e., from t₀ to t₁, according to this exemplary embodiment the measured traffic load for this licensed service in this traffic processor 102 goes down relative to the previous time interval as shown in FIG. 4. Since the license verification flag managed by local license manager 103 is set to “False”, there is no license verification for incoming traffic during this period. Thus, the traffic processor 102 serves all requests for messages without checking for the presence of license tokens and does not block or queue any message requests during this period (subject to its maximum capacity). At time t₁, local license manager 103 again retrieves the measured traffic load as having a value B<A. The local license manager 103 thus sends a second request toward license server 104 to reduce the number of reserved license tokens for this traffic processor 102 relative to the previous time interval since the traffic load has decreased. The number of reserved license tokens which are received from the license server 104 remains the same as the number requested (i.e., point B and B′ are the same). Thus the local license manager 103 sets the license flag to be “False” again for the next time interval.

During the time interval from t₁ to t₂, the traffic load increases. Since the license verification flag was set to “False”, the local license manager 103 again does not perform any license verification for incoming traffic during this period even though the load exceeds the number of tokens received which can be seen by the function 400 being above the line at B′. At time t₂, local license manager 103 retrieves the traffic load having a value of C>B. Local license manager follows the same procedure described above by requesting license tokens, receiving the number of tokens requested (i.e., point C and C′ are the same), and again setting (or leaving set) the license verification flag to a value of “False”.

During the time interval from t₂ to t₃, the traffic load first goes down and then up. Since the license verification flag is set to “False”, the local license manager 103 once again does not perform any license verification despite the large increase in service usage during this period. The time interval between requests for license tokens by a local license manager 103 may be the same according to some exemplary embodiments. Alternatively, in order to contain potentially unlicensed service activity, the time intervals between the periodic license token requests by local license manager 103 can be varied. At time t₃, the local license manager 103 retrieves the traffic load for this traffic processor 102 which has a value of D>C. The local license manager 103 again sends a request towards license server 104 to ask for new license tokens. However, unlike the previous responses in this example, this time the available number of license tokens (represented by point D′ in FIG. 4) is less than the number of requested license tokens (represented by point D). Hence only the number of license tokens corresponding to point D′ is returned to the local license manager 103. Therefore, the local license manager 103 sets the license verification flag to be “True”, which means that all the incoming requests shall be checked against obtained license tokens, i.e., the process enters state 306 in FIG. 3.

During the time interval from t₃ to t₄, the traffic load decreases. Local license manager 103 checks each incoming service request to determine whether there is another license token available since the control flag is set to “True”. If the number of ongoing service events in the traffic processor 102 is equal to or exceeds the number of reserved license tokens, then the local license manager 103 shall put the next incoming request at the end of a service queue. When one of the ongoing events is successfully terminated, the local license manager 103 can then instruct the, e.g., messaging application, to process the first request in the queue. At time t₄, local license manager 103 again retrieves the traffic load having a value of E<D. Local license manager 103 therefore sends a request which reduces the number of reserved license tokens for this traffic processor 102 since the traffic load has gone down. The number of reserved license tokens which are provided in the response message form the license server 104 in this example is equal to the number requested (i.e., point E and point E′ are the same in FIG. 4). The local license manager 103 then sets the license verification flag to be “False” again.

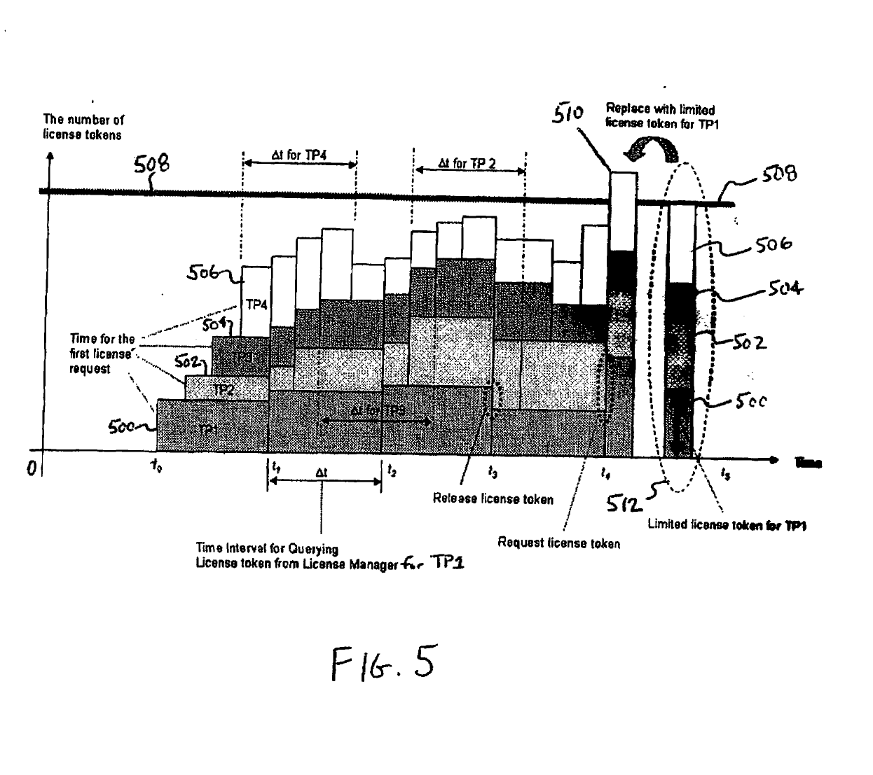

Exemplary embodiments also provide for complementary processing to that described above at the license server 104 as shown in the graph of FIG. 5. FIG. 5 shows the number of license tokens reserved by a license server 104 as a function of time for each traffic processor in a node, e.g., an application server. In this example, the node includes four traffic processors 102 as shown in FIG. 1. Each traffic processor 102 has its own defined time or time interval in which to query the license server 104 for license tokens as shown in FIG. 5. For example, as seen in the time interval between t₀ and t₁, traffic processor TP 1 queries the license server 104 first, followed by TP2, followed by TP3 and then by TP4. The time to query the license server can be different for each traffic processor 102 in order to alleviate the processing burden on the license server 104 which would otherwise occur if, e.g., all of the requests for tokens were received simultaneously.

At time t₀, the local license manager 103 in TP1 102 sends the first license request message towards the license server 104. The number of the license tokens (corresponding to the rectangle 500) requested by TP1 is then reserved by the license server, and a response message indicative of this reservation is transmitted back to the local license manager 103 in TP1. Subsequently, e.g., a few minutes later, the local license manager 103 in TP2 sends its license request message towards the license server 104. Again, the requested number of license tokens (corresponding to rectangle 502) is reserved, and a corresponding reservation response message is returned to TP2. The local license managers 103 in TP3 and TP4 follow the same procedure to query the license server 104 for license tokens resulting in the respective reservations as indicated by rectangles 504 and 506 in FIG. 5.

Token reservation requests continue during the next two time intervals, i.e., between time t₁ and time t₂ and then between time t₂ and time t₃, in a time offset or staggered manner as between the various traffic processors TP1-TP4. The time offset between requests from traffic processors 102, as well as their order within the time interval may, for example, be randomly generated. Each traffic processor 102 has its own time interval Δt between license token requests as shown in FIG. 5 which may be the same for each traffic processor 102, different for each traffic processor 102, or the same for some traffic processors 102 and different for others. As mentioned earlier, the time interval may also vary over time for each traffic processor 102. At time t₃, the local license manager 103 in TP1 sends a request to release a number of its previously reserved license tokens. As shown in FIG. 3 by the reduction in height of the rectangle 500, this request is honored by the license server 104 which again returns the requested number of license tokens.

Prior to time t₄, the license server 104 has reserved, in each instance, the number of license tokens requested by each traffic processor 102 at each time interval, since the total number of requested tokens has not exceeded the maximum number of tokens which are available at this node. This maximum number of available tokens is represented in FIG. 5 by the line 508. However, at time t₄, the local license manager 103 in TP1 sends a request to increase the number of the license tokens which it has reserved. If this request were to be completely honored by the license server 104, the total number of outstanding tokens 510 for all four traffic processors 102 would exceed the maximum number available 508. Since this is not permitted according to these exemplary embodiments, the request by TP1 is instead not completely fulfilled as shown by the actual license token grant in rectangle 500 of the set of blocks 512. More specifically, according to this exemplary embodiment, the license server 104 responds with only the number of tokens which remain such that the total does not exceed (or equals) the maximum number available 508.

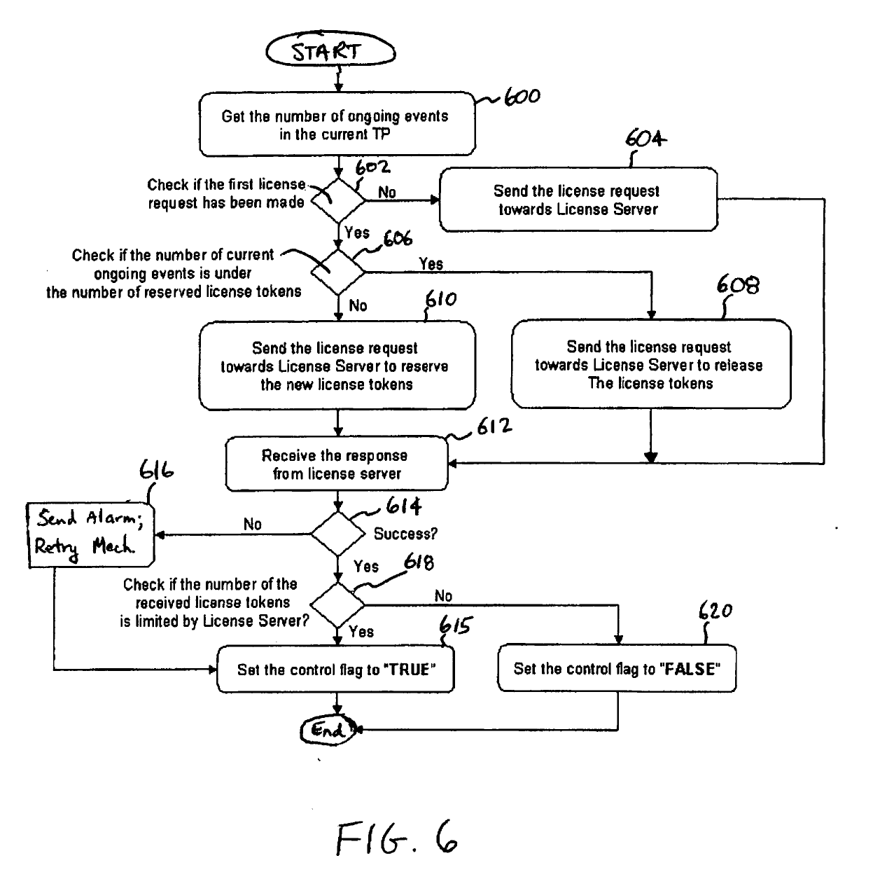

Referring now to the flowchart of FIG. 6, the local license manager 103 in the local traffic processor 102 can retrieve license tokens from the license server 104 by following the steps described therein according to an exemplary embodiment. When it is time to query the license server 104 (i.e., based on the fixed or variable time interval), the license manager 103 obtains a “snapshot” or measurement of the number of ongoing events that are controlled under the service license at step 600. The local license manager 103 checks to see if a first license request towards the license server 104 has already been sent at step 602. When no license request for the service has been to the license server 104 yet, the local license manager 103 follows the “No” branch of the flow to step 604, whereupon it sends the first license request to the license server 104 to reserve the number of license tokens based on the number of ongoing events obtained from the snapshot.

Alternatively, if the first license request has already been sent (following the “Yes” branch from block 602), the license manager 103 will instead compare the number of ongoing events with the number of reserved license tokens on this traffic processor 102 at step 606. If the number of ongoing events is under the number of reserved license tokens, the local license manager 103 sends a request to the license server 104 to release a number of reserved license tokens, which number is the difference between the number of ongoing events and the number of reserved license tokens. If the number of ongoing events exceeds the number of currently reserved license tokens, the local license manager 103 sends a request to reserve more license tokens accordingly at step 610.

The local license manager 103 then waits for the response from the license server 104 as shown by step 612. If the local license manager 103 receives any kind of error, e.g., license server unavailable, unknown license, etc., then the local license manager 103 can set the license verification flag to have the value “True” which will have the effect of blocking traffic for subsequent service requests. Here some form of graceful traffic handling could be implemented to keep both the operator and the service vendor informed, e.g., by sending an alarm and applying a retry mechanism, as shown in step 616. If, on the other hand, the local license manager 103 receives the response successfully, i.e., following the “Yes” branch from decision step 614, then the local license manager 103 can verify (at step 618) whether the number of reserved license tokens is the same as that in the request which was sent previously. If the number of reserved license tokens is reduced by the license server 104 relative to the number that was requested, then the local license manager 103 can set the control flag to “True” at step 615, which will force license verification for each incoming service request during the next time interval. Otherwise, if the license server 104 reserves the number of license tokens that was requested, then the local license manager 103 can set the control flag to “False” at step 620, which means that no license verification will be performed for service requests during the next time interval.

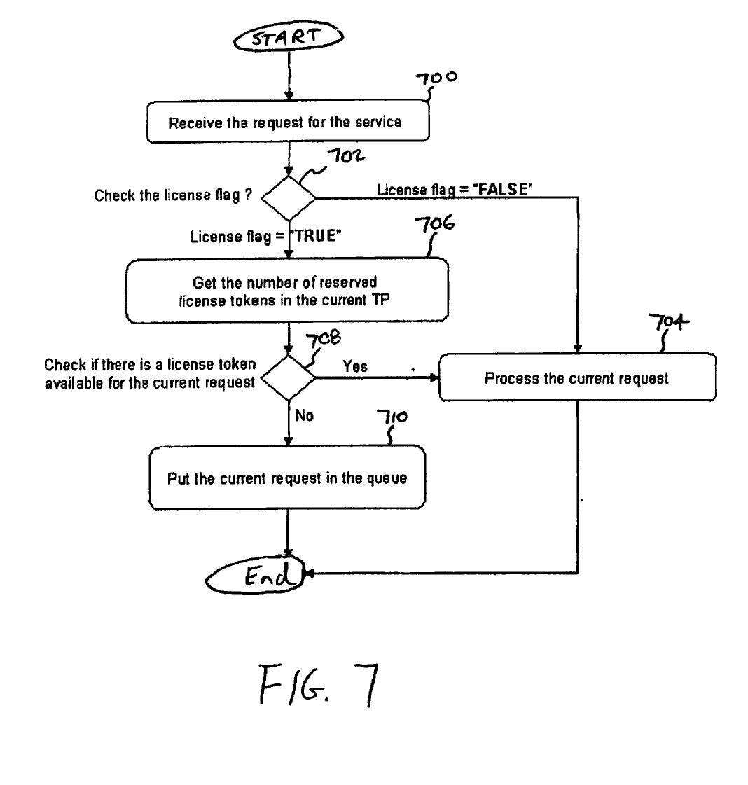

According to an exemplary embodiment, a method for license control for a new service request can be described as shown in the flow chart of FIG. 7. Therein, when a new request for the service is received at step 700, the license verification flag for license is checked at step 702. If the license verification flag is set to “False”, then no license control is required for this request and the service shall then process this service request at step 708. If, on the other hand, the license verification flag is set to “True”, the number of reserved license tokens received from the license server 104 can be used to check the total number of ongoing service events at step 708. If there is no license token available for this service request on the traffic processor 102, then this request will be put at the end of the queue at step 710, which request will be handled when a license token is available again on this processor, for instance, when a service event is terminated. If there is a license token available for this service request, following the “Yes” branch from decision block 708, then the service can use this license token and process this request.

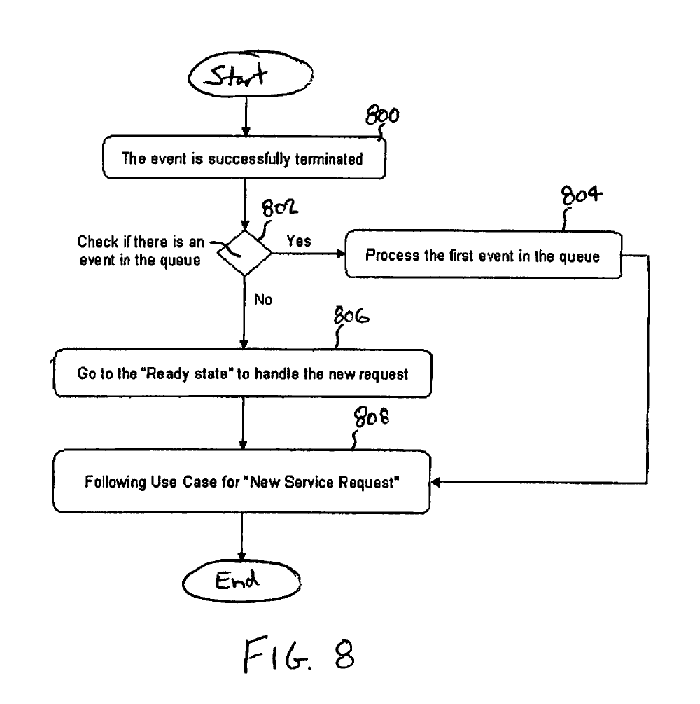

According to exemplary embodiments, license control for terminating existing service events can be implemented as described in the flowchart of FIG. 8. Therein, the service component, e.g., part of the application operating the service, can implement the illustrated steps to manage the queue that is designed for license verification. For example, when a service event is successfully terminated at step 800, the service component can check to see there are any pending requests in the queue at step 802. If there are pending requests in the queue, then the service component can process the first request in the queue at step 804. This can be accomplished by, for example, performing the steps illustrated in FIG. 7 as referenced by step 808. If, on the other hand, there are no pending service requests in the queue, the service component is then ready handling new requests from the end users as shown by step 806.

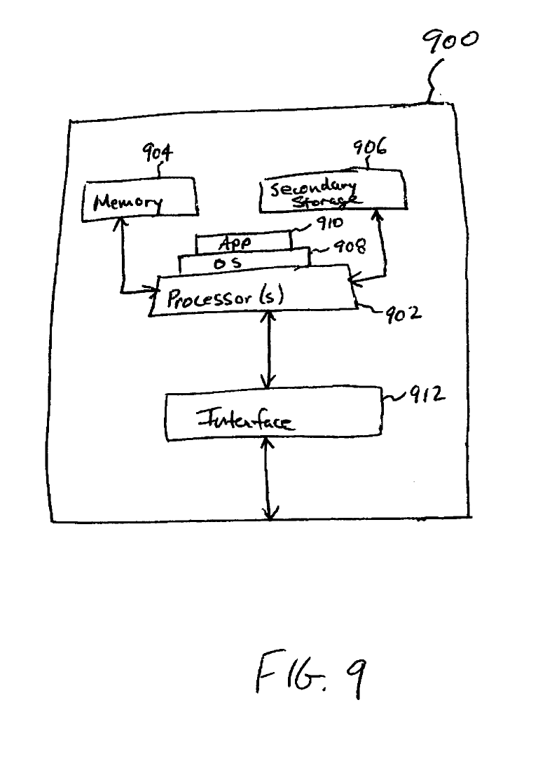

As described above, implementation of license control methods and associated communication services or the like according to these exemplary embodiments can impact messaging nodes in these types of systems. Structurally these nodes can, for example, be implemented in hardware and software as servers or resident on servers which may also serve other functions. For example, as shown generally in FIG. 9, such a server 900 can include one or more processors 902 (or multiple processor cores), memory 904, one or more secondary storage devices 906, an operating system 908 running on the processor(s) 902 and using the memory 904, as well as a one or more corresponding application(s) 910. An interface unit 912 may be provided to facilitate communications between the node 900 and the rest of the network or may be integrated into the processor(s) 902. Thus, such a communications node 900 could include, for example, at least one traffic processor for providing a communication service, e.g., a messaging service, and a local license manager entity, e.g., an application 910 operating on and associated with each of the processor(s) 902, which selectively processes an incoming request for the communication service without initially checking for compliance with a license associated with the communication service as described above.

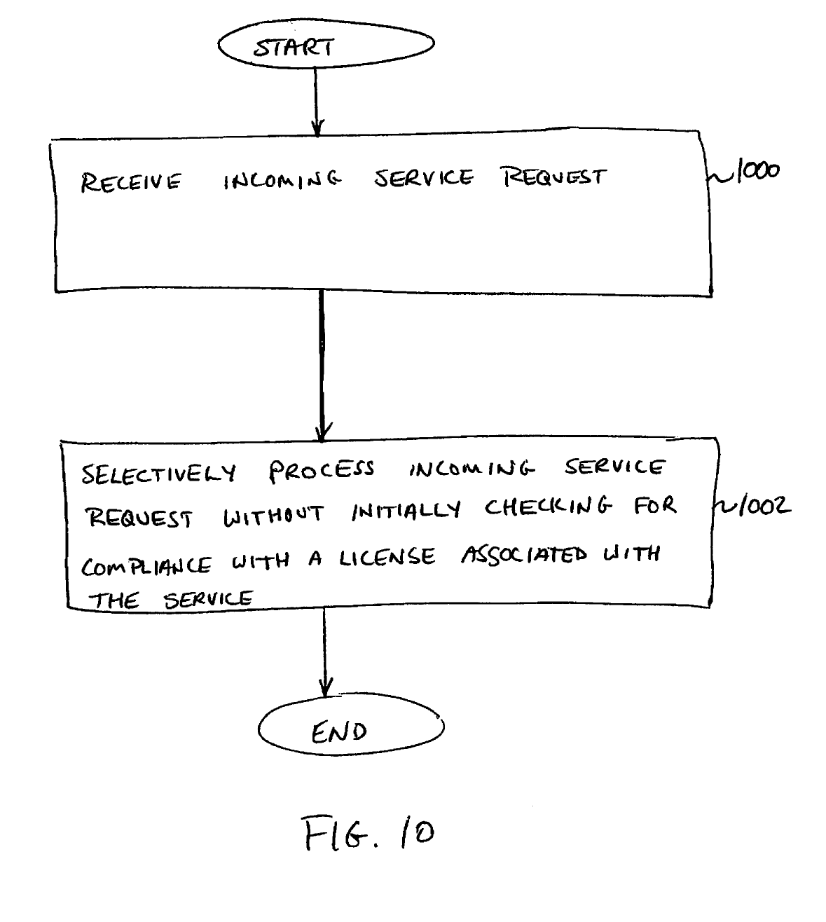

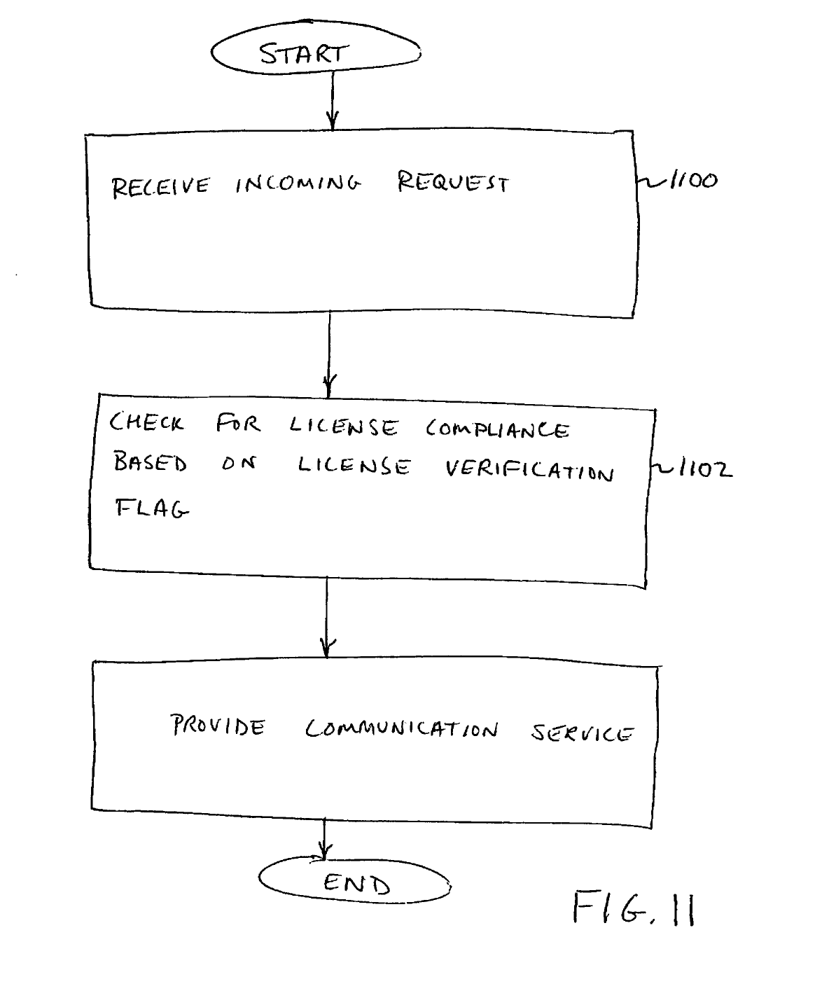

Likewise, a general method for monitoring license compliance in a communications network according to an exemplary embodiment can include the steps illustrated in the flowchart of FIG. 10. Therein, at step 1000, an incoming request for a communication service is received. Then, at step 1002, that incoming request is selectively processed without initially checking for compliance with a license associated with the communication service. Another general method for monitoring license compliance according to another exemplary embodiment can include the steps illustrated in the flowchart of FIG. 11. Therein, at step 1100, an incoming request for a communication service is received. Compliance with a license associated with the communication service can be selectively checked at step 1102 based upon a value of a license verification indicator. Then, at step 1104, the communication service requested can be provided.

The foregoing description of exemplary embodiments of the present invention provides illustration and description, but it is not intended to be exhaustive or to limit the invention to the precise form disclosed. Modifications and variations are possible in light of the above teachings or may be acquired from practice of the invention. The following claims and their equivalents define the scope of the invention.

1. A method for monitoring license compliance in a communications network comprising:
receiving an incoming request for a communication service;
checking for compliance with a license associated with said communication service based on a value of a license verification indicator; and
providing said communication service for said incoming request.

2. The method of claim 1 wherein said step of receiving incoming request for a communication service further comprises receiving, as said incoming request, request to send a message, and wherein said method for communicating further comprises:
sending said message.

3. The method of claim 2, wherein said message is one of a voice mail message, a short message service (SMS) message, a multimedia message service (MMS) message and an instant message (IM).

4. The method of claim 1, further comprising:
requesting a first number of license tokens based on a load associated with said communication service.

5. The method of claim 4, further comprising:
receiving a second number of license tokens in response to said requesting;
determining whether said first number equals said second number; and
setting said license verification indicator to a first value if said first number equals said second number and to a second value if said first number is different than said second number.

6. The method of claim 5, wherein said steps of checking for compliance with said license and providing said communication service further comprise:
processing said incoming request for said communication service by providing said communication service without initially checking for compliance with said license associated with said communication service if said license verification flag has said first value; and
otherwise, processing said incoming request by checking for compliance with said license if said license verification flag has said second value prior to providing said communication service.

7. The method of claim 6, wherein said step of processing said incoming request by initially checking for compliance with said license if said license verification flag has said second value further comprises:
determining whether one of said second number of license tokens is available for said incoming request;
if so, permitting said incoming request to be fulfilled by providing said communication service; and
if not, queuing said incoming request.

8. A communications node for providing a communication service comprising:
at least one traffic processor for providing said communication service; and
a local license manager entity, associated with each of said at least one traffic processors, which checks for compliance with a license associated with an incoming request for said communication service based on a value of a license verification indicator.

9. The communications node of claim 8, wherein said incoming request for said communication service is a request to send a message, and wherein said at least one traffic processor sends said message.

10. The communications node of claim 9, wherein said message is one of a voice mail message, a short message service (SMS) message, a multimedia message service (MMS) message and an instant message (IM).

11. The communications node of claim 8, wherein said local license manager entity requests a first number of license tokens based on a load associated with said communication service.

12. The communications node of claim 11, wherein said local license manager entity receives a second number of license tokens, determines whether said first number equals said second number, and sets said license verification indicator to a first value if said first number equals said second number and to a second value if said first number is different than said second number.

13. The communications node of claim 12, wherein said local license manager entity processes said incoming request by:
processing said incoming request for said communication service by providing said communication service without initially checking for compliance with said license associated with said communication service if said license verification flag has said first value; and
otherwise, processing said incoming request by checking for compliance with said license if said license verification flag has said second value prior to providing said communication service.

14. The communications node of claim 13, wherein said local license manager entity processes said incoming request by initially checking for compliance with said license if said license verification flag has said second value by determining whether one of said second number of license tokens is available for said incoming request, and
if so, permitting said incoming request to be fulfilled by providing said communication service; and
if not, queuing said incoming request.

15. A computer-readable medium containing program instructions which, when executed by a computer or processor, perform the steps of:
receiving an incoming request for a communication service;
checking for compliance with a license associated with said communication service based on a value of a license verification indicator; and
providing said communication service for said incoming request.

16. The computer-readable medium of claim 15 wherein said step of receiving said incoming request for a communication service further comprises receiving, as said incoming request, request to send message, and wherein said method for communicating further comprises:
sending said message.

17. The computer-readable medium of claim 16, wherein said message is one of a voice mail message, a short message service (SMS) message, a multimedia message service (MMS) message and an instant message (IM).

18. The computer-readable medium of claim 15, further comprising:
requesting a first number of license tokens based on a load associated with said communication service.

19. The computer-readable medium of claim 18, further comprising:
receiving a second number of license tokens in response to said requesting;
determining whether said first number equals said second number; and
setting said license verification indicator to a first value if said first number equals said second number and to a second value if said first number is different than said second number.

20. The computer-readable medium of claim 19, said steps of checking for compliance with said license and providing said communication service further comprise:
processing said incoming request for said communication service by providing said communication service without initially checking for compliance with said license associated with said communication service if said license verification flag has said first value; and
otherwise, processing said incoming request by checking for compliance with said license if said license verification flag has said second value prior to providing said communication service.

21. The computer-readable medium of claim 20, wherein said step of processing said incoming request by initially checking for compliance with said license if said license verification flag has said second value further comprises:
determining whether one of said second number of license tokens is available for said incoming request;
if so, permitting said incoming request to be fulfilled by providing said communication service; and
if not, queuing said incoming request.

22. A method for monitoring license compliance in a communications network comprising:
receiving an incoming request for a communication service; and
selectively processing said incoming request for said communication service without initially checking for compliance with a license associated with said communication service.

23. A method for monitoring license compliance in a communications network comprising:
providing service to incoming requests for a communication service;
measuring traffic associated with said provided service; and
subsequently checking for license compliance based on said measured traffic.
